(19) United States
(12) Patent Application Publication
(10) Pub. No.: US 2007/0185676 A1
(43) Pub. Date: Aug. 9, 2007

(54) Single camera three-point vision alignment system for a device handler

(75) Inventors: Kexiang Ken Ding, San Diego, CA (US); Steve Ade, Carlsbad, CA (US); Larry Stuckey, San Diego, CA (US)

Correspondence Address: FOLEY AND LARDNER LLP;SUITE 500, 3000 K STREET NW, WASHINGTON, DC, 20007, US

(73) Assignee: Delta Design, Inc.

(21) Appl. No.: 11/525,222

(22) Filed: Sep. 22, 2006

Related U.S. Application Data
(60) Provisional application No. 60/719,614, filed on Sep. 23, 2005.

(51) Int. Cl. G01P 21/00

(52) U.S. Cl. 702/94

(57) ABSTRACT

A vision alignment system for aligning a testing device includes an alignment camera positioned above an alignment portion of the vision alignment system. A lighting system for emitting light onto the device is located in proximity to the alignment camera. A calibration target is used to define a calibration target coordinate system. Three actuators are positioned in a testing portion of the vision alignment system, for correcting an offset between the calibration target and the testing device. A pick and place handler transports the calibration target and the testing device between the testing portion and the alignment portion.

### CROSS-REFERENCE TO RELATED PATENT APPLICATIONS

This application claims priority from Provisional U.S. Application No. 60/719,614, filed Sep. 23, 2005, incorporated herein by reference in its entirety.

### FIELD OF INVENTION

The present invention relates generally to device handlers, and more particularly to a single camera vision alignment system for a device handler used in semiconductor testing.

### BACKGROUND OF THE INVENTION

Semiconductor devices are commonly tested using specialized processing equipment. The processing equipment may be used to identify defective products and other various characteristics related to the performance of such devices. In most cases, the processing equipment possess handling mechanisms for handling devices under test. In order to insure accurate testing, handling mechanisms must be able to correctly align the device under test with various testing tools and equipment. Correct alignment of the devices is essential to efficient and accurate testing.

Various systems are used to position and align devices for testing, sorting and other functions. Generally, alignment is achieved using a mechanical alignment system. However, mechanical alignment is only accurate within certain manufacturing ranges and is not ideal for precise alignment operations. Further, modem devices lack accurate mechanical reference points, driving the need for an alternative to mechanical alignment.

Accordingly, conventional systems for aligning devices in processing equipment may use multiple cameras to calibrate the system. Once calibrated, the alignment mechanism is then able to align its devices appropriately. However, because of the use of multiple cameras, these systems are generally expensive, operationally complex, costly to maintain and have a larger than desired physical footprint.

Other handling and testing systems use real time vision alignment. Accordingly, alignment conditions for each device is determined independently and then the device is aligned accordingly. Since alignment is determined in these systems on a device-by-device basis, the alignment process may take an extended amount of time.

Therefore, an alignment system is needed that will align devices using simple cost-effective procedures. Further, an alignment system is needed that is capable of aligning several devices repeatedly without extensive delay.

### SUMMARY OF THE INVENTION

According to one embodiment of the invention, a vision alignment system includes an alignment camera positioned above an alignment portion of the vision alignment system, a lighting system located in proximity to the alignment camera, a calibration target, three actuators, positioned in a testing portion of the vision alignment system, for correcting an offset between the calibration target and a testing device, and a pick and place handler for transporting the calibration target and the testing device between the testing portion and the alignment portion.

According to another embodiment of the invention, the calibration target is configured to represent a contactor location for a tester apparatus.

According to yet another embodiment of the invention, the camera has a resolution of at least one mega pixel.

According to still another embodiment of the invention, a method for aligning a testing device in a handler system, includes the steps of pre-aligning a calibration target with a contactor of a testing apparatus, recording three actuation points to define a target coordinate system, determining the offset between the calibration target and the testing device and correcting the offset between the calibration target and the testing device.

### BRIEF DESCRIPTION OF THE DRAWINGS

FIG. 1 is a perspective view of a vision alignment system.

FIG. 2 is a top view of a calibration target on a testing side of a vision alignment system.

FIG. 3 is a top view of a calibration target on an alignment side of a vision alignment system.

FIG. 4 is a top view illustrating offset between a calibration target and a testing device.

FIG. 5 is a block diagram of an implementation of the vision alignment system using a vision guide plate.

### DETAILED DESCRIPTION OF THE PREFERRED EMBODIMENTS

An exemplary vision alignment system, according to the present invention, is now described in reference to the accompanying drawings. It will be appreciated that the alignment vision system may be used advantageously with a semiconductor device testing and handler machine. The handler uses the alignment vision system to align semiconductors for testing purposes. Of course, other applications may be apparent to those skilled in the art.

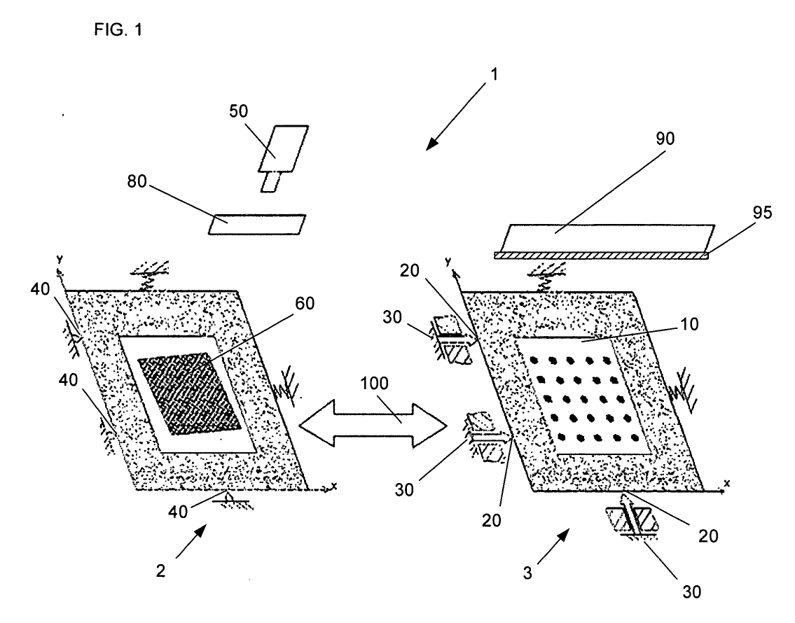

According to one embodiment of the invention, a vision alignment system 1 is shown in FIG. 1. The vision alignment system 1 has two sides, an alignment side 2 (shown on the left in FIG. 1) and a testing side 3 (shown on the right in FIG. 1).

On the testing side 3, the initial calibration of the system is carried out using a calibration target 10. The testing side 3 also includes three actuators 30 and a tester 90. On the alignment side 2, the alignment of a device to be tested 60 is determined. The alignment side 2 includes an alignment camera 50 and a lighting system 80.

A pick and place handler 100, positioned between the testing side 3 and the alignment side 2 is configured to transport calibration targets 10 and testing devices 60 from one side to another. The pick and place handler 100 is a rigid part carrier having solid part locking mechanisms. As shown in FIG. 1, the pick and place handler 100 is configured to transport a calibration target 10 from the testing side 3 to the alignment side 2. Conversely, the pick and place handler 100 can transport a testing device 60 from the alignment side 2 to the testing side 3. The vision alignment system 1 and its operation will now be described in further detail below.

In a vision alignment system 1, according to one embodiment of the invention, the calibration target 10 is used to represent the contactor location 95 (shown in one dimension for simplicity) of a tester 90. The tester 90 carries out various operations on a testing device 60 to determine, for example, the testing device's 60 operational characteristics. The contactor 95 of the tester 90 facilitates a connection between the tester 90 and a testing device 60. Thus, aligning a testing device 60 with the contactor 95 of a tester 90 is essential for accurate and efficient testing.

The vision alignment system 1 employs the calibration target 10 to represent the contactor location for alignment purposes. The calibration target 10 may be a two-dimensional pattern that provides visual contrast. According to one embodiment of the invention, the calibration target 10 is formed on a glass plate with chromium circles in a 5×5 matrix as shown in FIG. 1. According to another embodiment of the invention, the calibration target 10 may be a model device similar to the devices undergoing testing 60.

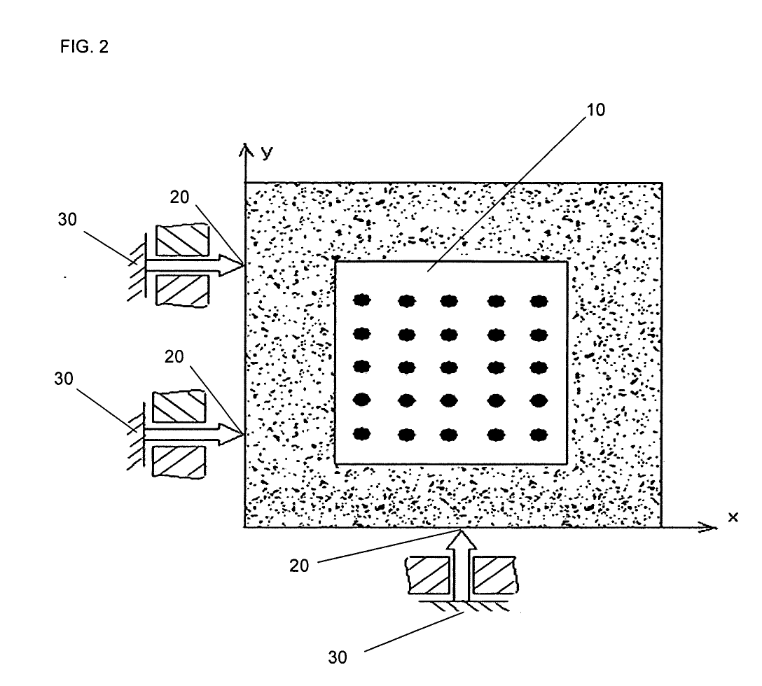

During operation, first, the calibration target 10 is pre-aligned with the contactor 95 of the tester 90 on the testing side 3 as shown in FIG. 1. The alignment may be implemented using several mechanisms including pins and pinholes. Once the calibration target 10 is aligned, the vision alignment system 1 records three actuating points 20 to define a calibration target 10 coordinate system. FIGS. 1 and 2 show three defined actuation points 20 of the target coordinate system. Each actuation point 20 represents the zero point for a corresponding actuator 30. The coordinate system of the calibration target 10 may now be used to accurately represent the contactor 95 position of the tester 90.

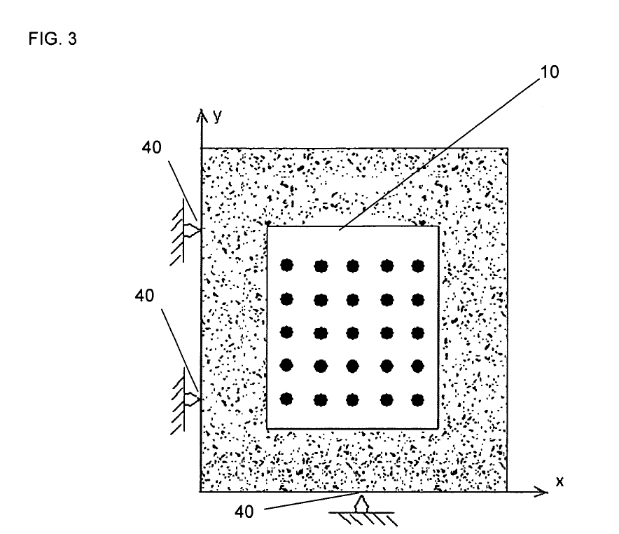

A testing device 60, initially located on the alignment side 2, must now be aligned with the calibration target 10 to insure that it will be aligned properly with the contactor 95. On the alignment side 2, target touching points 40 are used to define a camera coordinate system for a camera 50. The target touching points 40 are closely located in the same position relative to the testing device 60 as the corresponding actuation points 20 relative to the calibration target 10. According to one embodiment of the invention, FIGS. 1 and 3 show three target touching points 40 corresponding to three actuation points 20.

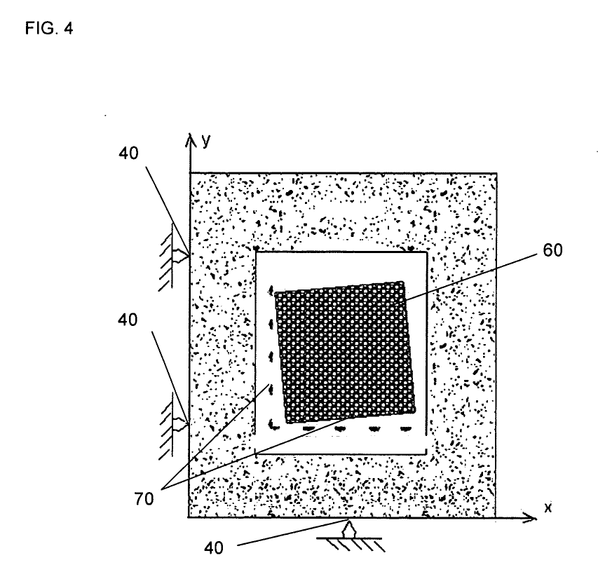

As shown in FIG. 1, the camera 50 is oriented such that it captures the orientation of a testing device 60 relative to the calibration target 10. The camera 50 can have any number of resolutions suitable for use in the alignment system 1. According to one embodiment of the invention, the camera 50 has a resolution of at least one mega pixel. Thus, the camera 50 can detect a large offset as well as a small offset in the testing device 60. As shown in FIG. 4, the camera 50 determines a position offset 70 between each of the testing devices 60 and the calibration target 10. Since the calibration target 10 represents the location of the contactor 95, the alignment system 1 can then determine the offset between the testing device 60 and the contactor 95.

In order for the camera 50 to accurately determine the position of a testing device 60, a lighting system 80 is also provided. According to one embodiment of the invention, the lighting system 80 is comprised of a five-channel programmable LED array light. The angle of light emitted onto the testing device 60 can be changed to provide light at an angle anywhere in the range of 0° to 90°. The lighting system 80 contains a processor (not shown) adapted to execute software that will configure the lighting system 80 so that the images captured by the camera 50 are of sufficient quality to determine offset 70. For example, the lighting system 80 is capable of providing lighting so that the images captured by the camera 50 have enhanced contrast. Further, the lighting system 80 is configured to execute a trainable vision algorithm that enables the system to accurately locate parts including a testing device 60.

Once the alignment system 1 determines the offset 70 of the testing device 60 relative to the calibration target 10, the testing device 60 is moved from the alignment side 2 to the testing side 3 via the pick and place handler 100. On the testing side 3, the actuators 30 are used to correct the offset 70. Preferably, three actuators 30, as shown in FIGS. 1 and 2 are located on the testing side 3. Once offset 70 has been cured, the testing device 60 is aligned with the contactor 95 for the purpose of testing.

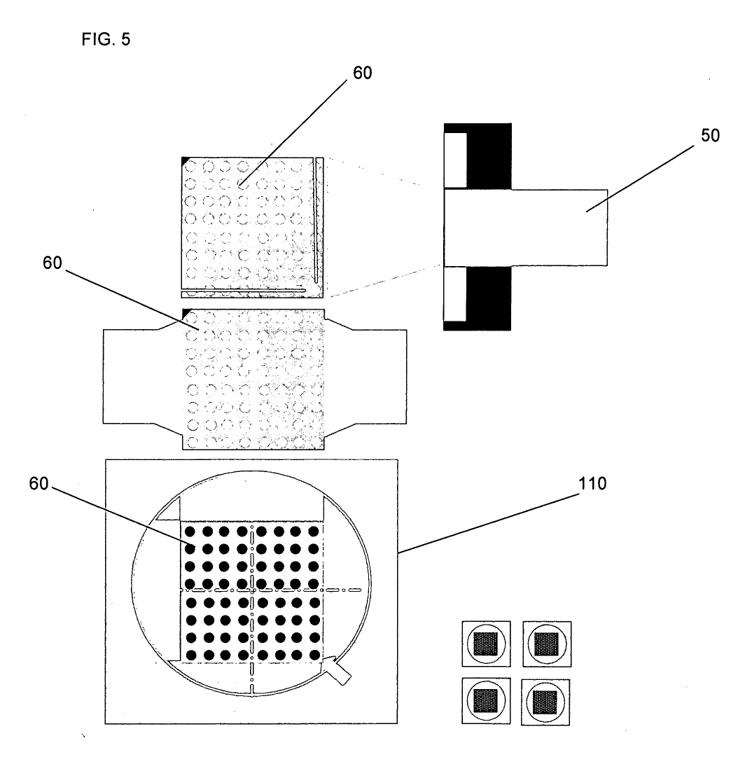

According to another embodiment of the invention, as shown in FIG. 5, a vision guide plate (VGP) 110 is used. The VGP 110 is a modular component that can be mounted to the contactor 95. In this embodiment, first, an image of the testing device 60 is captured by the camera 50 after the testing device 60 has been thermally soaked. The vision alignment system 1 stores the image and information obtained from the image. For example, information such as the “best fit” of the device 60 contact pattern and the position of the device 60 relative to a mechanical reference point are stored. Then, the testing device 60 is mounted onto the VGP 110 as shown in FIG. 5. Using the information obtained by the camera 50, the VGP 110 completes any mechanical adjustments to the testing device 60 before insertion into the contactor 95. In turn, calibration of the vision alignment system 1 can be achieved by focusing a camera 50 on the VGP 110 and contactor assembly. In addition, the VGP 110 allows the vision alignment system 1 to adapt to various test site patterns and other handler systems.

The VGP 110 provides several benefits and has a variety of uses. For example, in one embodiment of the invention, the VGP 110 is configured to include thermal control features. Thus, the VGP 110 can be used to thermally condition the contactor 95. Further, the VGP 110 is capable of detecting whether a device 60 is stuck in the contactor 95 and is capable of ejecting a device 60 from the contactor 95. In addition, the VGP 10 may be used to clean a contactor 95, validate the cleaning of a contactor 95 and detect bent pins.

According to certain aspects of the invention, certain advantages are realized. One advantage is that the present invention is compatible with multiple device handler systems. In addition, the error frequency for alignment calculations of the present invention is less than that of mechanical alignment systems. Further, the present invention is simpler and costs less to produce than other conventional systems.

Although the present invention has been described in reference to a particular embodiment, various other embodiments and modifications will be apparent to those skilled in the art. It is therefore intended that the foregoing description of a preferred embodiment be considered as exemplary only.

What is claimed is:

1. A vision alignment system, comprising:
an alignment camera positioned above an alignment portion of the vision alignment system;
a lighting system located in proximity to the alignment camera;
a calibration target;
three actuators positioned in a testing portion of the vision alignment system, for correcting an offset between the calibration target and a testing device; and
a handler for transporting the calibration target and the testing device between the testing portion and the alignment portion.

2. A vision alignment system as claimed in claim 1, wherein the calibration target is configured to represent a contactor location for a tester apparatus.

3. A vision alignment system as claimed in claim 1, wherein the camera has a resolution of at least one mega pixel.

4. A vision alignment system as claimed in claim 1, wherein the lighting system further comprises a programmable LED array.

5. A vision alignment system as claimed in claim 1, wherein the lighting system is configured to provide light at an angle in the range of 0° to 90° relative to the surface of the testing device.

6. A vision alignment system as claimed in claim 1, wherein the calibration target is formed on a glass plate using chromium circles positioned in a 5×5 array.

7. A vision alignment system as claimed in claim 1, wherein the calibration target is a model device representative of the devices undergoing testing.

8. A vision alignment system as claimed in claim 1, wherein the handler is a pick and place handler.

9. A vision alignment system as claimed in claim 1, wherein three target touching points positioned in the alignment portion are used to define a camera coordinate system for the alignment camera and the position of the three target touching points corresponds to the position of the three actuation points located in the testing portion of the vision alignment system.

10. A method for aligning a testing device in a handler system, comprising the steps of:
pre-aligning a calibration target with a contactor of a testing apparatus;
recording three actuation points to define a target coordinate system;
determining the offset between the calibration target and the testing device; and
correcting the offset between the calibration target and the testing device.

11. A vision alignment system, comprising:
A means for pre-aligning a calibration target with a contactor of a testing apparatus;
a means for recording three actuation points to define a target coordinate system;
a means for determining the offset between the calibration target and the testing device; and
a means for correcting the offset between the calibration target and the testing device.

12. A device testing system, comprising:
a vision alignment system, comprising:
an alignment camera positioned above an alignment portion of the vision alignment system;
a lighting system located in proximity to the alignment camera;
a calibration target;
three actuators positioned in a testing portion of the vision alignment system, for correcting an offset between the calibration target and a testing device; and
a handler for transporting the calibration target and the testing device between the testing portion and the alignment portion; and
a tester having a contactor for testing the operational characteristics of the testing device.

13. A device testing system, as claimed in claim 12, wherein the handler is a pick and place handler.
